(19) United States
(12) Patent Application Publication
(10) Pub. No.: US 2025/0082131 A1
(43) Pub. Date: Mar. 13, 2025

(54) PORTABLE KITCHEN VENTILATOR USED FOR POT BODY

(71) Applicant: HONGKONG HOCITY TECHNOLOGY LIMITED, HONG KONG (CN)

(72) Inventor: SAUWA FUNG, HONG KONG (CN)

(73) Assignee: HONGKONG HOCITY TECHNOLOGY LIMITED, HONG KONG (CN)

(21) Appl. No.: 18/486,594

(22) Filed: Oct. 13, 2023

(30) Foreign Application Priority Data
Sep. 11, 2023 (CN) 202311163257.4

(51) Int. Cl. A47J 36/38; A47J 36/06; B01D 39/10; B01D 39/16; B01D 39/20; B01D 46/00; B01D 46/10

(52) U.S. Cl. CPC A47J 36/38; A47J 36/06; B01D 39/10; B01D 39/1692; B01D 39/2055; B01D 46/0005; B01D 46/0036; B01D 46/0043; B01D 46/10; B01D 2239/065; B01D 2265/029; B01D 2273/30; B01D 2275/10; B01D 2279/35

(57) ABSTRACT

The present invention discloses a portable kitchen ventilator for a pot body, which includes a housing, an oil-blocking guard, a filter net assembly and a fan assembly, where the oil-blocking guard is provided at a lower part of the housing and covers a range to filter oil smoke; the filter net assembly is located in the middle of the oil-blocking guard, and is connected to the fan assembly; the oil smoke is absorbed via the fan assembly, and filtered via the filter net assembly, and the filtered gas is discharged from an air outlet. The portable kitchen ventilator of the present invention is placed on a pot body during use, and is provided on the pot body via the oil-blocking guard, and then the fan assembly is started, and oil smoke generated from cooking is pumped away, the oil smoke around the pot body is directly adsorbed.

### CROSS-REFERENCE TO RELATED APPLICATIONS

The application claims priority to Chinese patent application No. 202311163257.4, filed on Sep. 11, 2023, the entire contents of which are incorporated herein by reference.

### TECHNICAL FIELD

The present invention relates to the technical field of kitchen ventilators, in particular to a portable kitchen ventilator used for a pot body.

### BACKGROUND

A kitchen ventilator is a kitchen appliance that purifies the kitchen. It is installed above a kitchen range, and can draw away the waste from the combustion of the range and cooking fume harmful to a human body during cooking, discharge the fume to the outside while condensing and collecting same, reduces pollution, purifies the air, and has safety protection function of gas prevention and explosion prevention.

The kitchen ventilator needs to be cleaned regularly as it collects oil smoke. Generally, oil smoke is a large amount of volatile edible oil pyrolysis products and partial volatile products produced when cooking food at a high temperature above 220° C., mainly volatile oil, organic matter and its heating decomposition or cracking products. Simple cleaning cannot eliminate greasy dirt, and the kitchen ventilator must be cleaned with professional cleaning agent.

At present, a kitchen ventilator is commonly used for collecting and processing oil smoke. For example, patent application No. 199720006349.7 discloses a computer intelligent kitchen ventilator including a body composed of a housing, a fan and a keyboard, characterized in that: a controller is provided on the housing, and the controller is composed of a power supply circuit, a detection circuit, a signal response circuit, a display drive circuit, a controllable circuit and a microcomputer chip which are connected via a wire; the power supply circuit outputs to the detection circuit, the signal response circuit, the display drive circuit and the microcomputer chip respectively; and the microcomputer chip is connected to the detection circuit, the signal response circuit, the display drive circuit, the controllable circuit and the keyboard respectively via the wire. Further, patent application No. 201620382503.4 discloses an embedded folding range hood includes a housing, a fan assembly located in the housing, and a collecting chamber slidingly connected to the housing, wherein the bottom of the housing is provided with an opening, the collecting chamber at least partially disposed in the opening and connected to the housing through the slide rails, the slide rails are at least two groups, and the two sets of slide rails are disposed on different sides of the smoke collecting chamber.

Further, patent application 202110518693.3 discloses a smoke guide pipe and a kitchen ventilator. The smoke guide pipe includes a first pipe and a second pipe, and the first pipe and the second pipe are oppositely connected to form an outer pipe wall surface and an inner smoke guide channel, and the outer pipe wall surface is provided with a first drive transmission mechanism capable of swinging the first pipe relative to the second pipe.

However, there are various types of kitchen ventilators with multiple functions, but the kitchen ventilators need to be installed and fixed on a wall or a kitchen top. Although it is convenient for collecting the oil smoke, the long-term use of the kitchen ventilator will lead to excessive oil smoke accumulation, resulting in difficulties in cleaning, and daily cleaning will bring a certain burden to people.

Therefore, improvement is urgently needed.

### SUMMARY

Based on this, it is therefore a primary object of the present invention to provide a portable kitchen ventilator for a pot body, which is designed in the shape of a pot cover and is placed on the pot body during use to directly absorb the oil smoke from the pot body, and at the same time, the structure of the pot cover is convenient for washing and cleaning the oil smoke, thereby improving the convenience of cleaning the oil smoke.

Another object of the present invention is to provide a portable kitchen ventilator for a pot body, which not only has the function of preventing oil from splashing and filtering oil smoke, but also is simple and compact in structure, small and light, and convenient in cleaning and maintenance.

In order to achieve the above-mentioned objects, the technical solution of the present invention is:
a portable kitchen ventilator for a pot body, which is characterized by including a housing, an oil-blocking guard, a filter net assembly and a fan assembly, wherein the oil-blocking guard is provided at a lower part of the housing and covers a range to filter oil smoke; the filter net assembly is located in the middle of the oil-blocking guard, and is connected to the fan assembly; the oil smoke is absorbed via the fan assembly, and filtered via the filter net assembly, and the filtered gas is discharged from an air outlet;
the housing is divided into a filter net assembly outer cover, a fan assembly outer cover and a handle from bottom to top, wherein the filter net assembly is provided in the filter net assembly outer cover, the fan assembly is provided in the fan assembly outer cover, and a control circuit and a power supply are provided in the handle, which are convenient for people to use by hand;
an air outlet is provided on the fan assembly outer cover to facilitate the discharge of the gas after the action of condensation, filtration, adsorption, etc. from the air outlet; and
the oil-blocking guard is embedded in the filter net assembly outer cover and extends outward to cover the pot body.

Thus, according to the structure of the present invention, the oil-blocking guard is provided on the pot body, and then the fan assembly is started, so that the oil smoke generated from cooking and the extracted oil smoke passes through the filter net assembly to be condensed, filtered, and absorbed into the gas without oil smoke, and then is discharged through the air outlet.

Further, the filter net assembly is movably connected to the filter net assembly outer cover to facilitate disassembly.

Further, the filter net assembly is provided with a turnbuckle on the outside thereof, an outer wall of the turnbuckle is threaded, an inner wall of the filter net assembly outer cover is also threaded, threads of the turnbuckle and the filter net assembly outer cover cooperate with each other to achieve connection between the filter net assembly and the filter net assembly outer cover, and at the same time, it is also convenient to remove the filter net assembly for cleaning and maintenance.

Further, the filter net assembly includes a three-layer filter net including a Teflon punched mesh pack, a stainless-steel net, and an activated carbon sponge, through which the action of oil smoke condensation, filtration and adsorption are completed, so that the oil smoke can be sufficiently purified.

Further, the fan assembly includes a magnetic suction type fan blade which can be conveniently inserted and mounted, and a built-in electric motor, wherein the fan blade and a rotor of the electric motor are provided with 2-5 groups of magnets in a one-to-one correspondence, wherein the magnets generate a magnetic force, and the rotation of the rotor of the electric motor is transmitted to the fan blade via the magnetic force to drive the fan blade to rotate at a high speed, so that a negative pressure is generated at one side of the filter net assembly to facilitate suction of the oil smoke, so that the gas produced after the oil smoke experiences the action of condensation, filtration, adsorption, etc. of the filter net assembly is discharged from the air outlet.

Further, the oil-blocking guard is made of a steel ring and a stainless-steel net, which is easy to disassemble, replace or clean.

Further, the oil-blocking guard is made of a steel ring and an air-impermeable guard supported by the steel ring to facilitate the adsorption treatment of the oil smoke without exposing the oil smoke to the outside of the pot body.

Compared with the prior art, the technical effects of the present invention are as follows:
the present invention is designed in the shape of a pot cover, and is placed on a pot body during use, and is provided on the pot body via the oil-blocking guard, and then the fan assembly is started, and oil smoke generated from cooking is pumped away, the oil smoke around the pot body is directly adsorbed, and the pumped oil smoke passes through the filter net assembly for condensation, filtration and adsorption, and becomes a gas free from the oil smoke, and then is discharged through the air outlet. The portable kitchen ventilator for a pot body is convenient for people to use.

The structure of the pot cover of the present invention facilitates the washing and cleaning of the fume, and improves the convenience for cleaning the oil smoke. At the same time, the kitchen ventilator not only has the function of preventing oil from splashing and filtering oil smoke, but also is simple and compact in structure, small and light, and convenient in cleaning and maintenance, especially suitable for domestic and outdoor use.

### BRIEF DESCRIPTION OF DRAWINGS

FIG. 1 is a structural schematic diagram according to an embodiment of the present invention.

FIG. 2 is a structural sectional diagram according to an embodiment of the present invention.

FIG. 3 is a structural schematic diagram showing a filter net assembly according to an embodiment of the present invention.

FIG. 4 is a structural exploded diagram showing a filter net assembly according to an embodiment of the present invention.

FIG. 5 is a structural schematic diagram showing a fan assembly according to an embodiment of the present invention.

FIG. 6 is a structural schematic diagram showing an oil-blocking guard according to an embodiment of the present invention.

FIG. 7 is a side view according to an embodiment of the present invention.

FIG. 8 is a side view according to another embodiment of the present invention.

In the drawings: 1. housing; 2. oil-blocking guard; 3. filter net assembly; 4. fan assembly; 5. control circuit board; 6. battery; 7. recessed groove; 8. air outlet; 11. filter net assembly outer cover; 12. fan assembly outer cover; 13. handle; 21. steel ring; 22. stainless-steel net; 23. buckle edge; 31. turnbuckle; 32. Teflon punched mesh pack; 33. stainless-steel net; 34. activated carbon sponge; 311. turnbuckle thread; 111. air outlet; 112. Outer cover thread; 41. fan blade; 42. blade magnet; 43. built-in electric motor; 44. rotor; 45. rotor magnet.

### DETAILED DESCRIPTION OF THE EMBODIMENTS

In order that the objects, aspects and advantages of the present invention will become more apparent, a more particular description of the invention will be rendered by reference to the embodiments thereof which are illustrated in the appended drawings. It should be understood that the particular embodiments described herein are illustrative only and are not limiting.

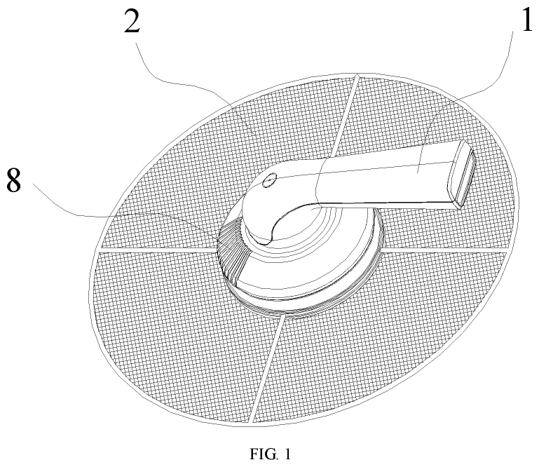

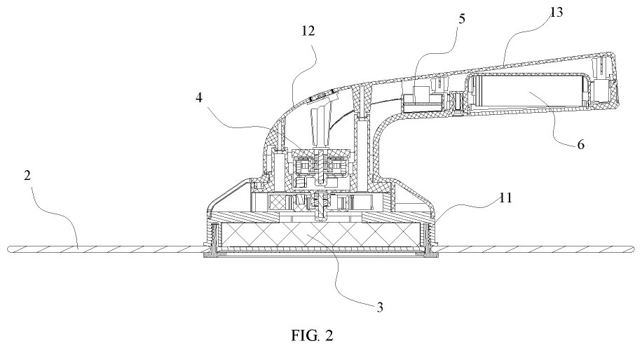

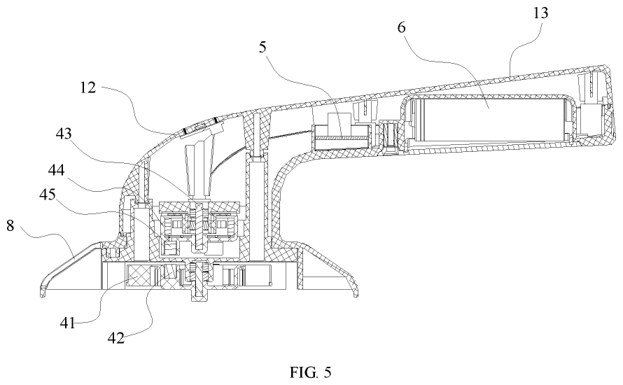

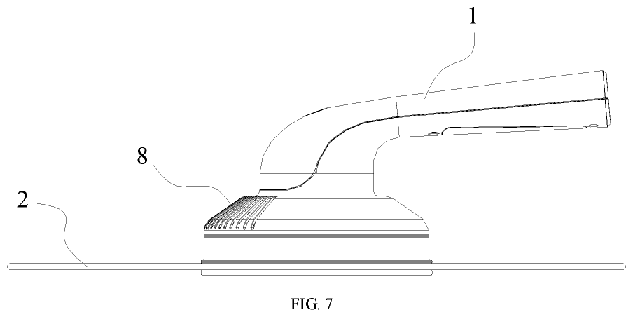

FIGS. 1-7 show a portable kitchen ventilator for a pot body implemented by the present invention. As shown in the figure, the kitchen ventilator includes a housing 1, an oil-blocking guard 2, a filter net assembly 3, and a fan assembly 4. The oil-blocking guard 2 is provided at a lower part of the housing 1 and covers a range to filter oil smoke; the filter net assembly 3 is located in the middle of the oil-blocking guard 2, and is connected to the fan assembly 4, absorbs the oil smoke via the fan assembly 4, and filters the oil smoke via the filter net assembly 3, and the filtered gas is discharged from an air outlet 8.

Specifically, the housing 1 is divided into three parts from bottom to top, namely, a filter net assembly outer cover 11, a fan assembly outer cover 12 and a handle 13, wherein the filter net assembly 3 is provided in the filter net assembly outer cover 11, a fan assembly 4 is provided in the outer cover 12, and a control circuit board 5 and a power supply 6 are provided in the handle 13, which are convenient for people to use by hand.

The power supply 6 supplies power to the fan assembly 4 and the control circuit board 5, and the control circuit board 5 controls opening and closing and operation of the fan assembly 4.

An air outlet 8 is provided on the fan assembly outer cover 12 to facilitate the discharge of the gas after the action of condensation, filtration, adsorption, etc. from the air outlet.

The oil-blocking guard is embedded in the filter net assembly outer cover and extends outward to cover the pot body. Specifically, a lower part of the filter net assembly outer cover 11 has a recessed groove 7 for embedding the oil-blocking guard 2.

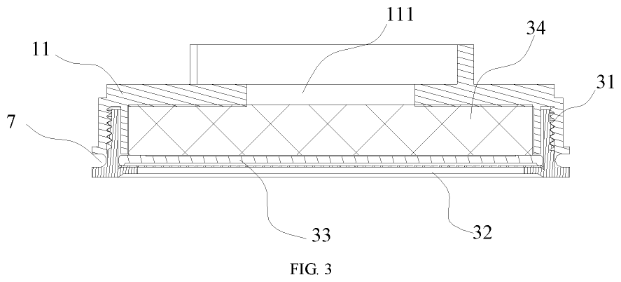

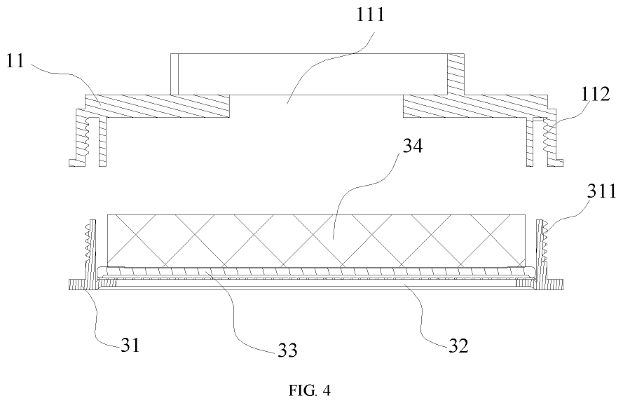

As shown in connection with FIGS. 3 and 4, the connection relationship between the filter net assembly 3 and the filter net assembly outer cover 11 is as shown. Firstly, the filter net assembly 3 and the filter net assembly outer cover 11 are movably connected to facilitate the disassembly and cleaning of the filter net assembly.

Specifically, the filter net assembly 3 includes a three-layer filter net including a Teflon punched mesh pack 32, a stainless-steel net 33 and an activated carbon sponge 33, wherein the Teflon punched mesh pack 32, the stainless-steel net 33 and the activated carbon sponge 33 are provided successively from the outside to the inside, the oil smoke is firstly condensed and preliminarily filtered through the Teflon punched mesh pack 32 and the stainless-steel net 33, and then the oil smoke is adsorbed through the activated carbon sponge 33, so that the oil smoke is sufficiently purified by completing the action of condensation, filtration and adsorption of the oil smoke through the three-layer filter net. A turnbuckle 31 is provided on the outside of the filter net assembly 3, and the turnbuckle 31 covers a Teflon punched mesh pack 32, a stainless-steel net 33 and an activated carbon sponge 33; the outer wall of the turnbuckle 31 is threaded 311, an inner wall of the filter net assembly outer cover is also threaded, and threads of the turnbuckle and the filter net assembly outer cover cooperate with each other to achieve connection between the filter net assembly and the filter net assembly outer cover, and at the same time, it is convenient to remove the filter net assembly for cleaning and maintenance.

For a fan assembly 4, which includes a magnetic suction type fan blade 41 which can be conveniently inserted and mounted, and a built-in electric motor 43, wherein the fan blade 41 and a rotor 44 of the built-in electric motor 43 are provided with three groups of magnets in a one-to-one correspondence, the magnets generate magnetic force, the fan blade magnet 42 of the fan blade 41, and the rotor magnet 45 on the rotor 44 transmit the rotation of the electric motor rotor 44 to the fan blade 41 via the magnetic force to drive the fan blade 41 to rotate at a high speed to generate a negative pressure on one side of the filter net assembly 3, facilitating the suction of oil smoke, and enabling the oil smoke to be discharged from the air outlet through the gas after the oil smoke passes through the functions of condensation, filtration and adsorption of the filter net assembly.

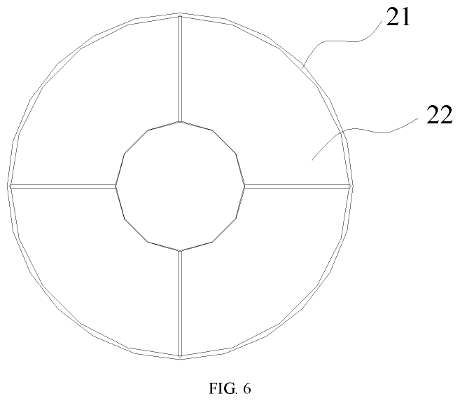

Referring to FIG. 6, the oil-blocking guard 2 is generally made of a steel ring 21 and a stainless-steel net 22, wherein the steel ring 21 has a circular shape and supports the stainless-steel net 22 to facilitate the disassembly, replacement or cleaning of the oil-blocking guard 2.

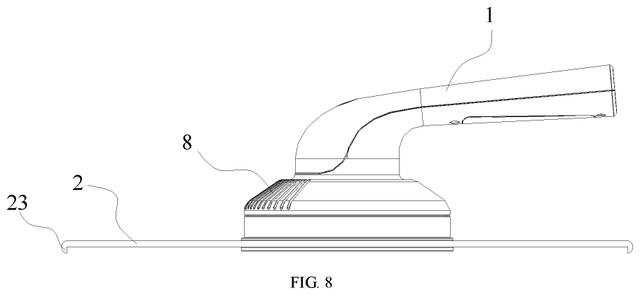

Referring to FIG. 8, another implementation of the oil-blocking guard 2 is shown, in which the oil-blocking guard 2 is made of a steel ring 21 and an air-impermeable guard 22 supported by the steel ring, and at the same time, a downwardly bent buckle edge 23 is provided at the edge to facilitate the adsorption treatment of oil smoke without exposing the oil smoke to the outside of the pot body.

To sum up, the present invention is designed in the shape of a pot cover, and is placed on a pot body during use, and is provided on the pot body via the oil-blocking guard, and then the fan assembly is started, and oil smoke generated from cooking is pumped away, the oil smoke around the pot body is directly adsorbed, and the pumped oil smoke passes through the filter net assembly for condensation, filtration and adsorption, and becomes a gas free from the oil smoke, and then is discharged through the air outlet, which is convenient for people to use.

At the same time, the present invention can only disassemble the filter net assembly to facilitate the washing and cleaning of the oil smoke, which is simple and fast, and improves the convenience for cleaning the oil smoke.

The present invention is simple and compact in structure, small and light, and convenient in cleaning and maintenance, especially suitable for domestic and outdoor use.

While the invention has been particularly shown and described with reference to preferred embodiments thereof, it will be understood by a person skilled in the art that various changes in form and details may be made therein without departing from the spirit and scope of the invention.

What is claimed is:

1. A portable kitchen ventilator for a pot body, comprising a housing, an oil-blocking guard, a filter net assembly and a fan assembly, wherein the oil-blocking guard is provided at a lower part of the housing and covers a range to filter oil smoke; the filter net assembly is located in the middle of the oil-blocking guard, and is connected to the fan assembly; the oil smoke is absorbed via the fan assembly, and filtered via the filter net assembly, and the filtered gas is discharged from an air outlet;
the housing is divided into a filter net assembly outer cover, a fan assembly outer cover and a handle from bottom to top, wherein the filter net assembly is provided in the filter net assembly outer cover, the fan assembly is provided in the fan assembly outer cover, and a control circuit and a power supply are provided in the handle, which are convenient for people to use by hand;
an air outlet is provided on the fan assembly outer cover to facilitate the discharge of the gas after the action of condensation, filtration, adsorption, etc., from the air outlet; and
the oil-blocking guard is embedded in the filter net assembly outer cover and extends outward to cover the pot body.

2. The portable kitchen ventilator for a pot body according to claim 1, wherein the filter net assembly is movably connected to the filter net assembly outer cover to facilitate disassembly.

3. The portable kitchen ventilator for a pot body according to claim 3, wherein the filter net assembly is provided with a turnbuckle on the outside thereof, an outer wall of the turnbuckle is threaded, an inner wall of the filter net assembly outer cover is also threaded, threads of the turnbuckle and the filter net assembly outer cover cooperate with each other to achieve connection between the filter net assembly and the filter net assembly outer cover.

4. The portable kitchen ventilator for a pot body according to claim 1, wherein the filter net assembly comprises a three-layer filter net comprising a Teflon punched mesh pack, a stainless-steel net, and an activated carbon sponge.

5. The portable kitchen ventilator for a pot body according to claim 1, wherein the fan assembly comprises a magnetic suction type fan blade which can be conveniently inserted and mounted, and a built-in electric motor, wherein the fan blade and a rotor of the electric motor are provided with 2-5 groups of magnets in a one-to-one correspondence, wherein the magnets generate a magnetic force, and the rotation of the rotor of the electric motor is transmitted to the fan blade via the magnetic force to drive the fan blade to rotate at a high speed, so that a negative pressure is generated at one side of the filter net assembly to facilitate suction of the oil smoke.

6. The portable kitchen ventilator for a pot body according to claim 1, wherein the oil-blocking guard is made of a steel ring and a stainless-steel net, which is easy to disassemble, replace or clean.

7. The portable kitchen ventilator for a pot body according to claim 1, wherein the oil-blocking guard is made of a steel ring and an air-impermeable guard supported by the steel ring.
